(19) United States
(12) Patent Application Publication
(10) Pub. No.: US 2025/0200767 A1
(43) Pub. Date: Jun. 19, 2025

(54) HETEROGENEOUS THREE-DIMENSIONAL OBSERVATION REGISTRATION BASED ON DEPTH PHASE CORRELATION METHOD, MEDIUM AND DEVICE

(71) Applicant: ZHEJIANG UNIVERSITY, Zhejiang (CN)

(72) Inventors: Yue WANG, Zhejiang (CN); Zexi CHEN, Zhejiang (CN); Haodong ZHANG, Zhejiang (CN); Rong XIONG, Zhejiang (CN)

(73) Assignee: ZHEJIANG UNIVERSITY, Zhejiang (CN)

(21) Appl. No.: 19/063,301

(22) Filed: Feb. 26, 2025

Related U.S. Application Data
(63) Continuation of application No. PCT/CN2023/071661, filed on Jan. 10, 2023.

(30) Foreign Application Priority Data
Sep. 13, 2022 (CN) 202211110592.3

(51) Int. Cl. G06T 7/32; G06T 3/147; G06T 3/20; G06T 3/40; G06T 3/60; G06T 7/33; G06T 7/37

(52) U.S. Cl. CPC G06T 7/32; G06T 3/147; G06T 3/20; G06T 3/40; G06T 3/60; G06T 7/337; G06T 7/37; G06T 2200/04; G06T 2207/10081; G06T 2207/10088; G06T 2207/10136; G06T 2207/20056; G06T 2207/20084; G06T 2207/30004

(57) ABSTRACT

Disclosed is a heterogeneous three-dimensional observation registration method, medium, and device based on depth phase correlation. The disclosure optimizes the phase correlation algorithm into a globally convergent differentiable phase correlation solver, and combines the solver with a simple feature extraction network, thereby a heterogeneous three-dimensional observation registration method whose overall framework is differentiable and capable of end-to-end training is established. The disclosure can achieve accurate three-dimensional observation registration for three-dimensional objects, scene measurements, and medical image data; and the registration performance is higher than the existing baseline model.

### CROSS-REFERENCE TO RELATED APPLICATION

This application is a continuation of international application of PCT application serial no. PCT/CN2023/071661 filed on Jan. 10, 2023, which claims the priority benefit of China application no. 202211110592.3, filed on Sep. 13, 2022. The entirety of each of the above mentioned patent applications is hereby incorporated by reference herein and made a part of this specification.

### BACKGROUND

### Technical Field

The disclosure belongs to the fields of computer vision and deep learning, and

particularly relates to a heterogeneous three-dimensional observation registration method based on depth phase correlation, medium, and device.

### Description of Related Art

Heterogeneous observation registration is a crucial technology in vision and robotics, which is used to register two observation objects with differences in, for example, angle, scale, or viewing angle. Also, the observation may be, for example, an image, a point cloud, or a mesh model.

In the existing technology, the patent with application number CN202110540496.1 discloses a heterogeneous image pose estimation and registration method based on neural network, device, and medium. This solution optimizes the phase correlation algorithm to be differentiable, embeds the algorithm into the end-to-end learning network framework, and constructs a heterogeneous image pose estimation method based on neural network. This method can find the optimal feature extractor based on the image matching results, thereby accurate pose estimation and registration of the heterogeneous images are accurately achieved. However, this registration method is only used in two-dimensional images and cannot achieve registration of three-dimensional observation objects.

For the registration of three-dimensional observations, especially the pose registration task of homogeneous and heterogeneous observations without initial value, the number of degrees of freedom may reach up to 7, which is higher than the registration task of two-dimensional images.

While learning-based methods have proven promising using differentiable solvers, the method either rely on heuristically defined correspondences or are prone to local optima. Therefore, for the registration of three-dimensional observations, designing a pose registration method that can be trained end-to-end to complete the matching of heterogeneous sensors is an urgent technical problem that needs to be solved in the existing technology.

### SUMMARY

The purpose of the disclosure is to solve the problem of difficulty in registration of three-dimensional observations in the related art, and to provide a heterogeneous three-dimensional observation registration method based on depth phase correlation.

The specific technical solutions adopted by the disclosure are as follows.

In the first aspect, the disclosure provides a heterogeneous three-dimensional observation registration method based on depth phase correlation, configured to register a three-dimensional and heterogeneous first target observation and a source observation, including the following.
S1. After pre-training, a first 3D U-Net network and a second 3D U-Net network are used as two feature extractors, and the heterogeneous first target observation and source observation are used as inputs of the two feature extractors respectively. Isomorphic features in the two observations are extracted to obtain isomorphic maps, namely a first 3D feature map and a second 3D feature map.
S2. Fast Fourier Transform is performed on the first 3D feature map and the second 3D feature map obtained in S1 to obtain 3D amplitude spectra thereof respectively.
S3. Spherical coordinate transformation is performed on the two 3D amplitude spectra obtained in S2, so that the spectra may be converted from the Cartesian coordinate system to the spherical coordinate system to become spherical characterizations. Then, the two spherical characterizations obtained are integrated from the inside to the outside along the inner radiuses thereof. All the characterization information in each spherical characterization is mapped to the spherical surfaces to obtain two spherical surface characterizations.
S4: Phase correlation solution is performed on the two spherical surface characterizations obtained in S3 to obtain a rotation transformation relationship therebetween.
S5: The first target observation is rotated according to the rotation transformation relationship R obtained in S4, thereby a second target observation only retaining the translation transformation and the scaling transformation with the source observation is obtained.
S6: After pre-training, a third 3D U-Net network and a fourth 3D U-Net network are used as two feature extractors, and the second target observation and the source observation obtained in S5 are used as inputs of the two feature extractors respectively. Isomorphic features in the two observations are extracted to obtain isomorphic maps, namely a third 3D feature map and a fourth 3D feature map.
S7: Fast Fourier Transform is performed on the third 3D feature map and the fourth 3D feature map obtained in S6 to obtain 3D amplitude spectra thereof respectively.
S8: The two 3D amplitude spectra obtained in S7 are accumulated along a Z axis, so that the two 3D amplitude spectra are compressed into 2D amplitude spectra respectively.
S9: Log-polar transformation is performed on the two 2D amplitude spectra obtained in S8, so that the spectra may be converted from the Cartesian coordinate system to the log-polar coordinate system, thereby the scaling transformation in the Cartesian coordinate system between the two 2D amplitude spectra is mapped to the translation transformation in the x direction in the logarithmic polar coordinate system.
S10: Phase correlation solution is performed on the two 2D amplitude spectra after coordinate transformation in S9 to obtain a translation transformation relationship therebetween in the logarithmic polar coordinate system, then remapping is performed according to the mapping relationship between the Cartesian coordinate system and the logarithmic polar coordinate system in S9 to convert the translation transformation relationship in the logarithmic polar coordinate system into a scaling transformation relationship in the Cartesian coordinate system.
S11: The first target observation is transformed according to the rotation transformation relationship R and the scaling transformation relationship Mu obtained in S4 and S10 at the same time, thereby a third target observation only retaining the translation transformation with the source observation is obtained.
S12: After pre-training, a fifth 3D U-Net network and a sixth 3D U-Net network are used as two feature extractors, and the third target observation obtained in S11 and the source observation are used as inputs of the two feature extractors respectively. Isomorphic features in the two observations are extracted to obtain isomorphic maps, namely a fifth 3D feature map and a sixth 3D feature map.
S13: Phase correlation solution is performed on the fifth 3D feature map and the sixth 3D feature map obtained in S12 to obtain a translation transformation relationship therebetween in the x direction.
S14: After pre-training, a seventh 3D U-Net network and an eighth 3D U-Net network are used as two feature extractors, and the third target observation obtained in S11 and the source observation are used as inputs of the two feature extractors respectively. Isomorphic features in the two observations are extracted to obtain isomorphic maps, namely a seventh 3D feature map and an eighth 3D feature map.
S15: Phase correlation solution is performed on the seventh 3D feature map and the eighth 3D feature map obtained in S14 to obtain a translation transformation relationship therebetween in the y direction.
S16: After pre-training, a ninth 3D U-Net network and a tenth 3D U-Net network are used as two feature extractors, and the third target observation obtained in S11 and the source observation are used as inputs of the two feature extractors respectively. Isomorphic features in the two observations are extracted to obtain isomorphic maps, namely a ninth 3D feature map and a tenth 3D feature map.
S17: Phase correlation solution is performed on the ninth 3D feature map and the tenth 3D feature map obtained in S16 to obtain a translation transformation relationship therebetween in the z direction.
S18. The first target observation is transformed simultaneously according to the rotation transformation relationship obtained in S4, the scaling transformation relationship obtained in S10, and the translation transformation relationship jointly obtained in S13, S15, and S17; and then the first target observation is registered to the source observation.

As a preferred option of the first aspect, the ten 3D U-Net networks used in the registration method are pre-trained, and the total loss function of the training is the weighted sum of the rotation transformation relationship loss, the scaling transformation relationship loss, the translation transformation relationship loss in the x direction, the translation transformation relationship loss in the y direction, and the translation transformation relationship loss in the z direction between the first target observation and the source observation.

As a preferred option of the first aspect, the weighted weights of the five losses in the total loss function are all 1.

As a preferred option of the first aspect, all five losses in the total loss function adopt L1 loss.

As a preferred option of the first aspect, the ten 3D U-Net networks used in the registration method are independent of each other.

As a preferred option of the first aspect, the observation types of the first target observation and the source observation are three-dimensional medical imaging data, three-dimensional scene measurement data, or three-dimensional object data.

As a preferred option of the first aspect, the rotation transformation relationship includes three degrees of freedom, which are respectively three rotation angles of zyz Euler angles.

As a preferred option of the first aspect, in S13, S15, and S17, the translation transformation relationships of the three dimensions of xyz are obtained simultaneously through phase correlation solution, while only the direction dimension corresponding to each of the steps is retained.

In the second aspect, the disclosure provides a computer-readable storage medium. A computer program is stored on the storage medium. When the computer program is executed by a processor, the heterogeneous three-dimensional observation registration method based on depth phase correlation as described in any option of the first aspects can be realized.

In the third aspect, the disclosure provides a computer electronic device, which includes a storage and a processor.

The storage is used to store computer programs.

The processor is configured to implement the heterogeneous three-dimensional observation registration method based on depth phase correlation as described in any option of the first aspect when executing the computer programs.

### BRIEF DESCRIPTION OF THE DRAWINGS

FIG. 1 is a schematic diagram of a pose estimation process according to a heterogeneous three-dimensional observation registration method of the disclosure.

FIG. 2 shows examples of registration result of three-dimensional object data.

FIG. 3 shows an example of registration result of MRI data and a three-dimensional CT medical image.

FIG. 4 shows an example of registration result of a three-dimensional CT medical image and 3D ultrasound data.

### DESCRIPTION OF THE EMBODIMENTS

The disclosure will be further elaborated and described below together with the accompanying drawings and specific embodiments. The technical features of various embodiments of the disclosure may be combined correspondingly as long as the features do not conflict with each other.

In the description of the disclosure, it should be understood that the terms “first” and “second” are only used for differentiation and description purposes, and may not be understood as indicating or implying relative importance or implicitly indicating the number of indicated technical features.

In the real world, three-dimensional observation data obtained through different sensors are often limited by the characteristics of the sensors themselves, such as angles, proportions, viewing angles, so there is heterogeneity in three-dimensional observations obtained from the same three-dimensional object. Moreover, the sensor is also be subjected to different forms of interference when obtaining data, and the interferences greatly increases the difficulty in registering two heterogeneous observations.

The disclosure optimizes the phase correlation algorithm into a globally convergent differentiable phase correlation solver, and combines the solver with a simple feature extraction network, thereby a heterogeneous three-dimensional observation registration method based on deep phase correlation is established. Specifically, the method first learns dense features from a pair of heterogeneous observations through feature extractors. Then, the features are converted into translation- and scale-invariant spectral characterizations based on Fast Fourier Transform and spherical radial aggregation, and the translation and scale are decoupled from rotation. Next, a differentiable phase correlation solver is used to gradually estimate the rotation, scale, and translation in the spectra independently and efficiently, thereby a pose estimation between the two heterogeneous three-dimensional observations are obtained, and registration can be performed based on the pose estimation. In the entire registration method, the method framework of the pose estimation is differentiable and can be trained end-to-end, with good interpretability and generalization capability.

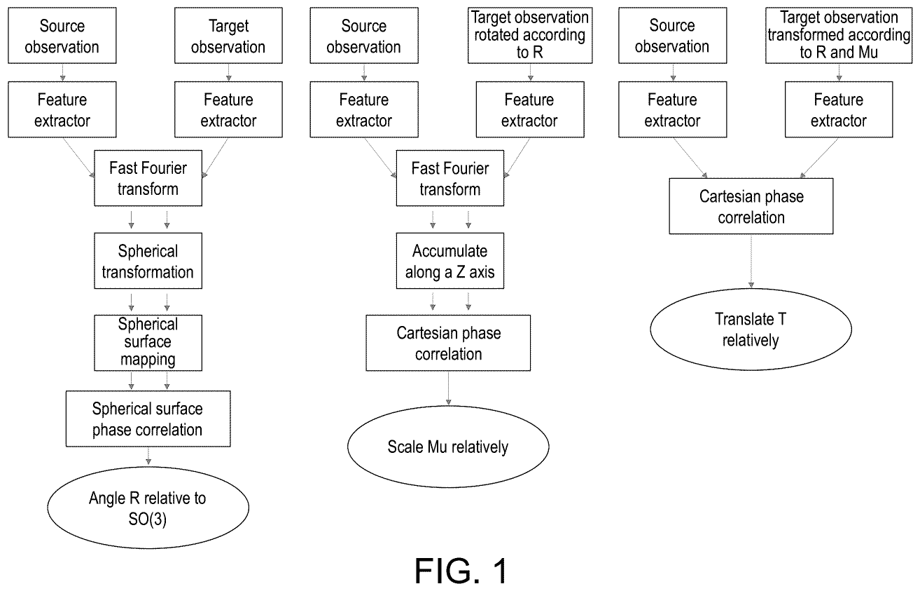

In a preferred embodiment of the disclosure, a specific implementation of a heterogeneous three-dimensional observation registration method based on depth phase correlation is provided. As shown in FIG. 1, FIG. 1 is a schematic diagram of a pose estimation process in this preferred embodiment. An original input for performing pose estimation and registration is a pair of heterogeneous three-dimensional observation data, respectively referred to as a first target observation and a source observation. The first target observation and the source observation are both three-dimensional observations, also referred to as three-dimensional characterizations. The specific observation type may be adjusted according to the actual situation, which may be three-dimensional medical imaging data (such as registering any two of a three-dimensional CT medical image, a nuclear magnetic resonance data, and 3D ultrasound data), three-dimensional scene measurement data (such as registering a three-dimensional laser point cloud measured by a robot), or three-dimensional object data (such as registering any two of a point cloud, a Mesh volume, and an SDF of a three-dimensional object).

In the disclosure, a pose estimation result between the first target observation and the source observation of the original input may be obtained through pose estimation. The pose estimation result comprises translation, rotation, and scaling transformation relationships of 7 degrees of freedom, thereby the first target observation is registered to the source observation. Among the 7 degrees of freedom of the pose estimation result, the translation transformation relationship includes three degrees of freedom xyz; the rotation transformation relationship may be an SO(3) rotation relationship, which also includes three degrees of freedom; and the scaling transformation relationship includes one degree of freedom.

In order to achieve the pose estimation with the 7 degrees of freedom, the disclosure constructs ten independent trainable 3D U-Net networks in the three stages of rotation, scaling, and translation for the first target observation and the source observation. After being pre-trained under the supervision of the three types of losses of translation, rotation, and scaling, the ten 3D U-Net networks may extract isomorphic features, that is, common features, from the heterogeneous three-dimensional observations, thereby the two heterogeneous three-dimensional observations are converted into isomorphic three-dimensional characterizations. The 3D U-Net network is a network that learns three-dimensional segmentation from sparsely annotated three-dimensional stereo data. In the network, the basic model structure and principle are similar to the 2D U-Net network, including the encoding path part and the decoding path part. The difference lies in the 3D generalization compared to the 2D U-Net network, that is, the convolution, deconvolution, and pooling operation in the encoding path part and the decoding path part are expanded from two dimensions to three dimensions. The specific model structure and principle of the 3D U-Net network belong to the existing technology and may be implemented by directly utilizing the existing network model, so details will not be repeated here.

It should be noted that among the 7 degrees of freedom in the disclosure, the scaling transformation relationship comprising only 1 degree of freedom is predicted by a set of two 3D U-Net networks, and the rotation transformation relationship comprising 3 degrees of freedom is also predicted by only a set of two 3D U-Net networks for overall prediction, but in the translation transformation relationship, the x-direction translation, y-direction translation, and z-direction translation are decoupled, the translation transformation in each direction requires training a separate set of two 3D U-Net networks for prediction to achieve improved accuracy.

The specific implementation process of the heterogeneous three-dimensional observation registration method based on depth phase correlation is described in detail below. The original inputs are the source observation as a template and the first target observation as a registration object. The registration steps are as follows.
S1. After pre-training, a first 3D U-Net network and a second 3D U-Net network are used as two feature extractors, and the heterogeneous first target observation and source observation are used as inputs of the two feature extractors respectively. Isomorphic features in the two observations are extracted to obtain isomorphic maps, namely a first 3D feature map and a second 3D feature map. At this time, the translation, rotation, and scaling transformation relationships between the original inputs are retained between the first 3D feature map and the second 3D feature map.
S2. Fast Fourier Transform is performed on the first 3D feature map and the second 3D feature map obtained in S1 to obtain 3D amplitude spectra thereof respectively. The rotation and scaling transformation relationship between the original inputs are retained between the two 3D amplitude spectra obtained at this time, while the translation transformation relationship has been filtered out.
S3. Spherical coordinate transformation is performed on the two 3D amplitude spectra obtained in S2, so that the spectra may be converted from the Cartesian coordinate system to the spherical coordinate system to become spherical characterizations. Then, the two spherical characterizations obtained are integrated from the inside to the outside along the inner radiuses thereof (that is, the integration is carried out in the radius direction from the center of the sphere to the spherical surface). All the characterization information in each spherical characterization is mapped to the spherical surfaces to obtain two spherical surface characterizations. At this time, the scaling relationship between the two spherical surface characterization is removed, and an SO(3) rotation relationship between the two spherical surfaces is the rotation relationship between the original inputs.
S4: Phase correlation solution is performed on the two spherical surface characterizations obtained in S3 to obtain a rotation transformation relationship therebetween (denoted as R).

It should be noted that the phase correlation solution for spherical surface characterization belongs to the existing technology and may be implemented through a combination of spherical Fast Fourier Transform, element dot product calculation, and SO(3) inverse Fast Fourier Transform, so details will not be repeated here. The rotation transformation relationship obtained by solving the problem is the SO(3) rotation relationship comprising three degrees of freedom. In this embodiment, the zyz Euler angle may be used. Therefore, the R obtained by solving the problem actually comprises three rotation angles of zyz Euler angles. At this time, R is a three-dimensional tensor. Certainly, in addition to the zyz Euler angle used in this embodiment, other Euler angle transformation forms may also be used.

The above rotation transformation relationship R is essentially the angle required to be rotated that the first target observation is registered to the source observation.
S5: The first target observation is rotated according to the rotation transformation relationship R obtained in S4, thereby a second target observation only retaining the translation transformation and the scaling transformation with the source observation is obtained. At this time, the second target observation is still heterogeneous with the source observation but only retaining the translation and scaling transformation relationships, while the rotation transformation relationship has been removed.
S6: After pre-training, a third 3D U-Net network and a fourth 3D U-Net network are used as two feature extractors, and the second target observation and the source observation obtained in S5 are used as inputs of the two feature extractors respectively. Isomorphic features in the two observations are extracted to obtain isomorphic maps, namely a third 3D feature map and a fourth 3D feature map. At this time, the translation and scaling transformation relationships between the original inputs are retained between the third 3D feature map and the fourth 3D feature map, but there is no rotation transformation relationship.
S7: Fast Fourier Transform (FFT) is performed on the third 3D feature map and the fourth 3D feature map obtained in S6 to obtain 3D amplitude spectra thereof respectively. The rotation and scaling relationship between the original inputs are retained between the two 3D amplitude spectra obtained at this time, while the translation relationship is filtered out.

It should be noted that the function of Fast Fourier Transform is to perform Fast Fourier Transform on the 3D feature maps extracted by the 3D U-Net network, removing the translation transformation relationship between the feature maps but retaining the rotation and scaling transformation relationships. According to the characteristics of Fast Fourier Transform, only the rotation and scale have an impact on the amplitude of the spectrum, but the amplitude of the spectrum is not sensitive to translation. Therefore, after introducing FFT, a representation manner insensitive to translation but particularly sensitive to scaling and rotation is obtained, and translation may be ignored when solving scaling and rotation subsequently.
S8: The two 3D amplitude spectra obtained in S7 are accumulated along a Z axis, so that the two 3D amplitude spectra are compressed into 2D amplitude spectra respectively. S9: Log-polar transformation (LPT) is performed on the two 2D amplitude spectra obtained in S8, so that the spectra may be converted from the Cartesian coordinate system to the log-polar coordinate system, thereby the scaling transformation in the Cartesian coordinate system between the two 2D amplitude spectra is mapped to the translation transformation in the x direction in the logarithmic polar coordinate system.

It should be noted that in the logarithmic polar transformation, log-polar transformation is performed on the amplitude spectra after FFT transformation and 2D compression, and the spectra are mapped from the Cartesian coordinate system to the logarithmic polar coordinate system. In this mapping process, the scaling and rotation transformations in the Cartesian coordinate system may be converted into translation transformation in the logarithmic polar coordinate system.
S10: Phase correlation solution is performed on the two 2D amplitude spectra after coordinate transformation in S9 to obtain a translation transformation relationship therebetween in the logarithmic polar coordinate system, then remapping is performed according to the mapping relationship between the Cartesian coordinate system and the logarithmic polar coordinate system in S9 to convert the translation transformation relationship in the logarithmic polar coordinate system into a scaling transformation relationship in the Cartesian coordinate system (denoted as Mu).

It should be noted that phase correlation solution is to calculate the cross-correlation between the two 2D amplitude spectra. According to the correlation obtained by performing the solution, the translation transformation relationship between the two spectra may be obtained. The specific calculation process of cross-correlation belongs to the existing technology, so details will not be repeated here. The translation transformation relationship obtained by phase correlation solution needs to be re-converted to the Cartesian coordinate system to form a relative scaling transformation relationship between the first target observation and the source observation. It may be seen that the coordinate system conversions in S9 and S10 actually belong to a completely corresponding process, and the mapping relationships between the two operations are inverse.

The scaling transformation relationship Mu is essentially the scale Mu required to be scaled in a case that the first target observation is registered to the source observation.
S11: The first target observation is transformed according to the rotation transformation relationship R and the scaling transformation relationship Mu obtained in S4 and S10 at the same time, thereby a third target observation only retaining the translation transformation with the source observation is obtained. At this time, the third target observation is still heterogeneous with the source observation input but only retaining the translation transformation relationship at this time, and the rotation transformation relationship and the scaling transformation relationship have been removed.
S12: After pre-training, a fifth 3D U-Net network and a sixth 3D U-Net network are used as two feature extractors, and the third target observation obtained in S11 and the source observation are used as inputs of the two feature extractors respectively. Isomorphic features in the two observations are extracted to obtain isomorphic maps, namely a fifth 3D feature map and a sixth 3D feature map. At this time, only the translation transformation relationship between the fifth 3D feature map and the sixth 3D feature map is retained, while there is no rotation transformation relationship or scaling transformation relationship.
S13: Phase correlation solution is performed on the fifth 3D feature map and the sixth 3D feature map obtained in S12 to obtain a translation transformation relationship therebetween in the x direction (denoted as Tx).

The translation transformation relationship Tx is essentially the distance Tx required to be translated in the x direction in a case that the first target observation is registered to the source observation.
S14: After pre-training, a seventh 3D U-Net network and an eighth 3D U-Net network are used as two feature extractors, and the third target observation obtained in S11 and the source observation are used as inputs of the two feature extractors respectively. Isomorphic features in the two observations are extracted to obtain isomorphic maps, namely a seventh 3D feature map and an eighth 3D feature map.
S15: Phase correlation solution is performed on the seventh 3D feature map and the eighth 3D feature map obtained in S14 to obtain a translation transformation relationship therebetween in the y direction (denoted as Ty).

The translation transformation relationship Ty is essentially the distance Ty required to be translated in the y direction in a case that the first target observation is registered to the source observation.
S16: After pre-training, a ninth 3D U-Net network and a tenth 3D U-Net network are used as two feature extractors, and the third target observation obtained in S11 and the source observation are used as inputs of the two feature extractors respectively. Isomorphic features in the two observations are extracted to obtain isomorphic maps, namely a ninth 3D feature map and a tenth 3D feature map.
S17: Phase correlation solution is performed on the ninth 3D feature map and the tenth 3D feature map obtained in S16 to obtain a translation transformation relationship therebetween in the z direction (denoted as Tz).

The translation transformation relationship Tz is essentially the distance Tz required to be translated in the z direction in a case that the first target observation is registered to the source observation.

It should be noted that in the operations S13, S15, and S17, although the translations in the three directions of xyz are decoupled and a translation transformation relationship in only one of the directions is obtained in each of the operations, when actually performing phase correlation solution, the translation transformation relationships of the three direction dimensions of xyz may still be obtained simultaneously through phase correlation solution, while only the direction dimension corresponding to each of the steps is retained. That is to say, in S13, the translation transformation relationships of the three direction dimensions of xyz are simultaneously obtained through phase correlation solution, but only the translation transformation Tx in the x direction is retained; in S15, the translation transformation relationships of the three direction dimensions of xyz are simultaneously obtained through phase correlation solution, but only the translation transformation Ty in the y direction is retained; and in S17, the translation transformation relationships of the three direction dimensions of xyz are simultaneously obtained through phase correlation solution, but only the translation transformation Tz in the z direction is retained. Finally, an overall translation transformation relationship T=(Tx, Ty, Tz) may be obtained by combining the translations in the three directions. In order to achieve a case that the first target observation is registered to the source observation, it is required to perform the overall translation transformation T in the three directions.

It may be seen that the pose estimation of the disclosure is implemented in three stages. The pose estimation of the three transformation relationships of rotation, scaling, and translation is carried out stage by stage. Finally, estimated transformations values of a total of 7 degrees of freedom (R, Mu, and T, in which R and T both have three degrees of freedom) are obtained. Based on the results of the estimated transformations values of the 7 degrees of freedom, heterogeneous observation registration may be performed between the first target observation and the source observation.
S18. The first target observation is transformed simultaneously according to the rotation transformation relationship R obtained in S4, the scaling transformation relationship Mu obtained in S10, and the translation transformation relationship (Tx, Ty, and Tz) jointly obtained in S13, S15, and S17; and then the first target observation is registered to the source observation.

It should be noted that in the registration process, the ten 3D U-Net networks used to estimate R, Mu, and T are independent of each other and all need to be pre-trained. In order to ensure that each 3D U-Net network may accurately extract isomorphic features, a reasonable loss function needs to be set. The ten 3D U-Net networks are trained together under the same training framework, and a total loss function of the training should be a weighted sum of the rotation transformation relationship loss (i.e. the loss of R), the scaling transformation relationship loss (i.e. the loss of Mu), the translation transformation relationship loss in the x direction (i.e. the loss of Tx), the translation transformation relationship loss in the y direction (i.e. the loss of Ty), and the translation transformation relationship loss in the z direction (i.e. the loss of Tz) between the first target observation and the source observation, and specific weighting values may be adjusted according to actual conditions.

In this embodiment, weighted weights of the five losses in the total loss function are all 1, and all five losses use L1 loss. For ease of description, the rotation transformation relationship R predicted in S4 is denoted as rotation_predict, the scaling transformation relationship Mu predicted in S10 is denoted as scale_predict, the translation transformation relationship Tx in the x direction predicted in S13 is denoted as x_predict, the translation transformation relationship Ty in the y direction predicted in S15 is denoted as y_predict, and the translation transformation relationship Tz in the z direction predicted in S17 is denoted as z_predict. Therefore, during each round of training, R, Mu, and (Tx, Ty, Tz) between the two heterogeneous three-dimensional observations may be obtained based on the current parameters of the model, and then the total loss function L is calculated according to the following process and network parameters are updated.
1) A 1-norm distance loss between the rotation_predict obtained and a true value thereof rotation_gt is calculated, L_rotation=(rotation_gt-rotation_predict). The L_rotation is passed back to train the first 3D U-Net network and the second 3D U-Net network, so that the networks may extract better features for rotation_predict.
2) A 1-norm distance loss between the scale_predict obtained and a true value thereof scale_gt is calculated, L_scale=(scale_gt-scale_predict). The L_scale is passed back to train the third 3D U-Net network and the fourth 3D U-Net network, so that the networks may extract good features for calculating scale_predict.
3) A 1-norm distance loss between the x_predict obtained and a true value thereof x_gt is calculated, L_x=(x_gt-x_predict). L_x is passed back to train the fifth 3D U-Net network and the sixth 3D U-Net network, so that the networks may extract good features for calculating x_predict.
4) A 1-norm distance loss between the y_predict obtained and a true value thereof y_gt is calculated, L_y=(y_gt-y_predict). L_y is passed back to train the seventh 3D U-Net network and the eighth 3D U-Net network, so that the networks may extract good features for calculating y_predict.
5) A 1-norm distance loss between the z_predict obtained and a true value thereof z_gt is calculated, L_z=(z_gt-z_predict). L_z is passed back to train the ninth 3D U-Net network and the tenth 3D U-Net network, so that the networks may extract good features for calculating z_predict.
6) The total loss function is calculated, L=L_x+L_y+L_z+L_rotation+L_scale. With the goal of minimizing L, the parameters of the ten 3D U-Net networks are updated through the gradient descent algorithm.

The ten 3D U-Net networks after training may be used to perform pose estimation between the two heterogeneous three-dimensional observations in the operations S1˜S18, and image registration may be performed based on estimation results.

In order to further evaluate the technical effect of the registration method described in S1˜S18 of the disclosure, actual tests are conducted on different three-dimensional observation types.

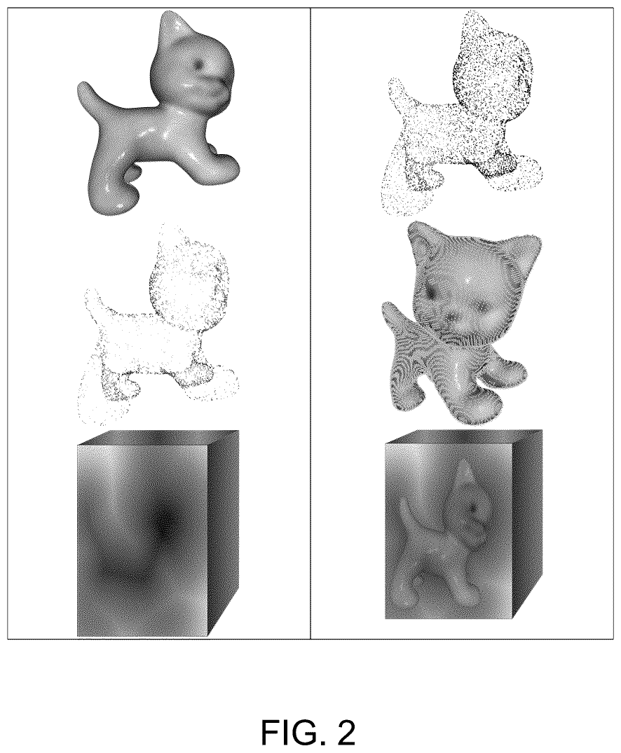

As shown in FIG. 2, FIG. 2 shows results of registration by using three-dimensional object data as the three-dimensional observation type according to the registration method described in S1˜S18. In FIG. 2, the left column comprises three types of different three-dimensional object data. From top to bottom, the types of data are Mesh volume, point cloud, and SDF of the same three-dimensional animal. Moreover, the point cloud is incomplete, that is, the observation is partially incomplete. The right column respectively shows a registration result of the incomplete point cloud, a registration result of the point cloud and the Mesh volume, and a registration result of the Mesh volume and the SDF after registration according to the method of the disclosure. It may be seen from the results that the disclosure can achieve accurate posture registration for different types of three-dimensional object data, and can achieve accurate good results in registration with the partial observation and registration with heterogeneous characterizations.

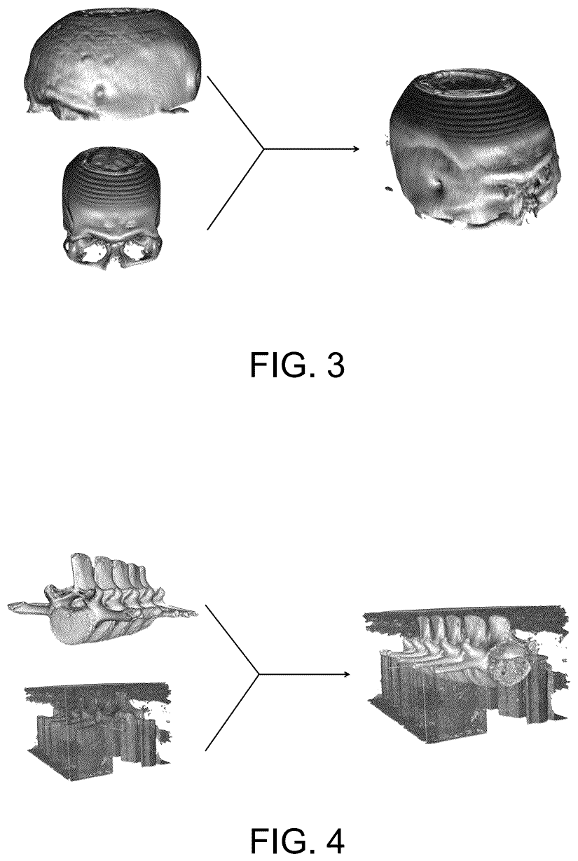

As shown in FIG. 3, FIG. 3 shows a result of registration by using three-dimensional medical image data as the three-dimensional observation type according to the registration method described in S1˜S18. In FIG. 3, the left column shows two heterogeneous inputs, which are three-dimensional MRI data and a three-dimensional CT medical image of the human brain. The right column shows the registration result between the two heterogeneous three-dimensional observations. As shown in FIG. 4, FIG. 4 also shows a result of registration by using three-dimensional medical imaging data as the three-dimensional observation type according to the registration method described in S1˜S18. In FIG. 4, the left column shows two heterogeneous inputs, which are a three-dimensional CT medical image of the human bone tissue and 3D ultrasound data of soft tissue attached to bone tissue. The right column shows the registration result between the two heterogeneous three-dimensional observations. It may be seen from the results that the disclosure can achieve accurate posture registration for different types of three-dimensional medical image data.

In addition, the disclosure also evaluates the precision of point cloud registration for three-dimensional scene measurement data. The three-dimensional scene measurement data comes from a 3DMatch data set, which collects data from 62 scenes and is commonly used for tasks such as key points, feature descriptors, and point cloud registration of 3D point clouds. When the registration method described in S1˜S18 of the disclosure is tested on the 3Dmatch data set, success criteria are that a registration translation error is less than 10 cm and a registration angle is less than 10 degrees. Final success rates are as shown in Table 1 below.

TABLE 1

| | Scenes | | | | | | | |
|---|---|---|---|---|---|---|---|---|
| | | | | | | | MIT | |
| | | | | | | | lab- | |
| Pre- | Home | Home | Hotel | Hotel | Hotel | Study | ora- | time |
| cision | 1 | 2 | 1 | 2 | 3 | room | tory | (ms) |
| Low | 93.55 | 91.22 | 94.77 | 93.11 | 95.77 | 92.33 | 92.11 | 177 |
| Medium | 94.44 | 92.22 | 95.66 | 95.33 | 96.22 | 94.11 | 92.66 | 23 |
| High | 96.22 | 94.11 | 96.11 | 95.99 | 97.33 | 94.77 | 93.55 | 377 |

Note:
Low, medium, and high in the table represent low precision, medium precision, and high precision with bandwidths of 64, 128, and 256 respectively.

It may be seen from the results that the disclosure can achieve accurate posture registration for three-dimensional scene measurement data in the form of point clouds.

Similarly, based on the same inventive concept, another preferred embodiment of the disclosure also provides a computer electronic device corresponding to the heterogeneous three-dimensional observation registration method based on depth phase correlation provided in the embodiments, which includes a storage and a processor.

The storage is used to store a computer program.

The processor is configured to implement the heterogeneous three-dimensional observation registration method based on depth phase correlation when executing the computer program.

Therefore, based on the same inventive concept, another preferred embodiment of the disclosure also provides a computer-readable storage medium corresponding to the heterogeneous three-dimensional observation registration method based on depth phase correlation provided in the embodiments. The storage medium stores a computer program. When the computer program is executed by the processor, the heterogeneous three-dimensional observation registration method based on depth phase correlation may be implemented.

Specifically, in the computer-readable storage medium or storage of the two embodiments, the computer program stored is executed by the processor and the steps in the processes in S1˜S18 can be executed. Each step in the processes may be implemented in the form of a program module. In other words, the steps in the processes in S1˜S18 may be implemented in the form of a software product. The computer software product is stored in a storage medium, which includes several commands for enabling a computer device (which may be, for example, a personal computer, a server, or a network device) to execute all or part of the steps of the method described in various embodiments of the disclosure.

It may be understood that the storage medium and the storage may use random access memory (RAM), or may use non-volatile memory (NVM), such as at least one disk storage. At the same time, the storage medium may also be various media storing program codes, for example, a USB flash drive, a portable storage device, a floppy disk, or a CD.

It may be understood that the processor may be a general-purpose processor, including, for example, a central processing unit (CPU), or a network processor (NP); or the processor may also be a digital signal processor (DSP), an application specific integrated circuit (ASIC), a field-programmable gate array (FPGA), or other programmable logic devices, discrete gates or transistor logic devices, discrete hardware components.

The embodiments are only a preferred solution of the disclosure, but the embodiments are not intended to limit the disclosure. Persons of ordinary skill in the relevant technical fields may also make various changes and modifications without departing from the spirit and scope of the disclosure. Therefore, any technical solution obtained by adopting equivalent substitution or equivalent transformation shall fall within the protection scope of the disclosure.

Compared with the related art, the disclosure has beneficial effects as the following.

The disclosure optimizes the phase correlation algorithm into a globally convergent differentiable phase correlation solver, and combines the solver with a simple feature extraction network, thereby a heterogeneous three-dimensional observation registration method based on deep phase correlation is established. The method can perform pose registration on any three-dimensional observation object without initial value. In the heterogeneous three-dimensional observation registration method based on deep phase correlation, the entire method framework is differentiable and can be trained end-to-end, with good interpretability and generalization capability. Test results show that the disclosure can achieve accurate three-dimensional observation registration for three-dimensional objects, scene measurements, and medical image data; and the registration performance is higher than the existing baseline model.

What is claimed is:

1. A heterogeneous three-dimensional observation registration method based on depth phase correlation, configured to perform three-dimensional and heterogeneous registration on a first target observation and a source observation, comprising:
S1. using a first 3D U-Net network and a second 3D U-Net network after pre-training as two feature extractors, using the heterogeneous first target observation and the source observation as inputs of the two feature extractors respectively, and extracting isomorphic features in the two observations to obtain isomorphic maps of a first 3D feature map and a second 3D feature map;
S2. performing Fast Fourier Transform on the first 3D feature map and the second 3D feature map obtained in S1 to obtain 3D amplitude spectra thereof respectively;
S3. performing spherical coordinate transformation on the two 3D amplitude spectra obtained in S2, so that the spectra are converted from a Cartesian coordinate system to a spherical coordinate system to become spherical characterizations; and integrating the two obtained spherical characterizations from inside to outside along inner radiuses thereof, and mapping all characterization information in each of the spherical characterizations to spherical surfaces to obtain two spherical surface characterizations;
S4: performing phase correlation solution on the two spherical characterizations obtained in S3 to obtain a rotation transformation relationship therebetween;
S5: rotating the first target observation according to the rotation transformation relationship obtained in S4, thereby obtaining a second target observation only retaining a translation transformation and a scaling transformation with the source observation;
S6: using a third 3D U-Net network and a fourth 3D U-Net network after pre-training as two feature extractors, using the second target observation obtained in S5 and the source observation as inputs of the two feature extractors respectively, and extracting isomorphic features in the two observations to obtain isomorphic maps of a third 3D feature map and a fourth 3D feature map;
S7: performing Fast Fourier Transform on the third 3D feature map and the fourth 3D feature map obtained in S6 to obtain 3D amplitude spectra thereof respectively;
S8: accumulating the two 3D amplitude spectra obtained in S7 along a Z axis, so that the two 3D amplitude spectra are compressed into 2D amplitude spectra respectively;
S9: performing log-polar transformation on the two 2D amplitude spectra obtained in S8, and converting from the Cartesian coordinate system to a logarithmic polar coordinate system, thereby the scaling transformation in the Cartesian coordinate system between the two 2D amplitude spectra is mapped to a translation transformation in an x direction in the logarithmic polar coordinate system;
S10: performing phase correlation solution on the two 2D amplitude spectra after coordinate transformation in S9 to obtain a translation transformation relationship therebetween in the logarithmic polar coordinate system, and remapping according to the mapping relationship between the Cartesian coordinate system and the logarithmic polar coordinate system in S9 to convert the translation transformation relationship in the logarithmic polar coordinate system into a scaling transformation relationship in the Cartesian coordinate system;
S11: transforming the first target observation according to the rotation transformation relationship and the scaling transformation relationship obtained in S4 and S10 at the same time, thereby obtaining a third target observation only retaining the translation transformation with the source observation;
S12: using a fifth 3D U-Net network and a sixth 3D U-Net network after pre-training as two feature extractors, using the third target observation and the source observation obtained in S11 as inputs of the two feature extractors respectively, and extracting isomorphic features in the two observations to obtain isomorphic maps of a fifth 3D feature map and a sixth 3D feature map;
S13: performing phase correlation solution on the fifth 3D feature map and the sixth 3D feature map obtained in S12 to obtain a translation transformation relationship therebetween in the x direction;
S14: using a seventh 3D U-Net network and an eighth 3D U-Net network after pre-training as two feature extractors, using the third target observation and the source observation obtained in S11 as inputs of the two feature extractors respectively, and extracting isomorphic features in the two observations to obtain isomorphic maps of a seventh 3D feature map and an eighth 3D feature map;
S15: performing phase correlation solution on the seventh 3D feature map and the eighth 3D feature map obtained in S14 to obtain a translation transformation relationship therebetween in a y direction;
S16: using a ninth 3D U-Net network and a tenth 3D U-Net network after pre-training as two feature extractors, using the third target observation and the source observation obtained in S11 as inputs of the two feature extractors respectively, and extracting isomorphic features in the two observations to obtain isomorphic maps of a ninth 3D feature map and a tenth 3D feature map;
S17: performing phase correlation solution on the ninth 3D feature map and the tenth 3D feature map obtained in S16 to obtain a translation transformation relationship therebetween in a z direction; and
S18. transforming the first target observation simultaneously according to the rotation transformation relationship obtained in S4, the scaling transformation relationship obtained in S10, and the translation transformation relationship jointly obtained in S13, S15, and S17; and
registering the first target observation to the source observation.

2. The registration method according to claim 1, wherein the ten 3D U-Net networks adopted in the registration method are pre-trained, and a total loss function of the training is a weighted sum of a rotation transformation relationship loss between the first target observation and the source observation, a scaling transformation relationship loss, a translation transformation relationship loss in the x direction, a translation transformation relationship loss in the y direction, and a translation transformation relationship loss in the z direction.

3. The registration method according to claim 1, wherein weighted weights of five losses in a total loss function are all 1.

4. The registration method according to claim 1, wherein all five losses in a total loss function adopts L1 loss.

5. The registration method according to claim 1, wherein the ten 3D U-Net networks adopted in the registration method are independent of each other.

6. The registration method according to claim 1, wherein observation types of the first target observation and the source observation are three-dimensional medical image data, three-dimensional scene measurement data, or three-dimensional object data.

7. The registration method according to claim 1, wherein the rotation transformation relationship comprises three degrees of freedom, which are respectively three rotation angles of zyz Euler angles.

8. The registration method according to claim 1, wherein in S13, S15, and S17, the translation transformation relationships of the three dimensions of xyz are obtained simultaneously through phase correlation solution, while only the dimension corresponding to each of the steps is retained.

9. A computer-readable storage medium, wherein a computer program is stored in the storage medium, and when the computer program is executed by a processor, the heterogeneous three-dimensional observation registration method based on depth phase correlation as described in claim 1 is realized.

10. A computer-readable storage medium, wherein a computer program is stored in the storage medium, and when the computer program is executed by a processor, the heterogeneous three-dimensional observation registration method based on depth phase correlation as described in claim 2 is realized.

11. A computer-readable storage medium, wherein a computer program is stored in the storage medium, and when the computer program is executed by a processor, the heterogeneous three-dimensional observation registration method based on depth phase correlation as described in claim 3 is realized.

12. A computer-readable storage medium, wherein a computer program is stored in the storage medium, and when the computer program is executed by a processor, the heterogeneous three-dimensional observation registration method based on depth phase correlation as described in claim 4 is realized.

13. A computer-readable storage medium, wherein a computer program is stored in the storage medium, and when the computer program is executed by a processor, the heterogeneous three-dimensional observation registration method based on depth phase correlation as described in claim 5 is realized.

14. A computer-readable storage medium, wherein a computer program is stored in the storage medium, and when the computer program is executed by a processor, the heterogeneous three-dimensional observation registration method based on depth phase correlation as described in claim 6 is realized.

15. A computer-readable storage medium, wherein a computer program is stored in the storage medium, and when the computer program is executed by a processor, the heterogeneous three-dimensional observation registration method based on depth phase correlation as described in claim 7 is realized.

16. A computer-readable storage medium, wherein a computer program is stored in the storage medium, and when the computer program is executed by a processor, the heterogeneous three-dimensional observation registration method based on depth phase correlation as described in claim 8 is realized.

17. A computer electronic device, comprising a storage and a processor, wherein
the storage is configured to store computer programs;
the processor is configured to implement the heterogeneous three-dimensional observation registration method based on depth phase correlation as described in claim 1 when executing the computer program.

18. A computer electronic device, comprising a storage and a processor, wherein
the storage is configured to store computer programs;
the processor is configured to implement the heterogeneous three-dimensional observation registration method based on depth phase correlation as described in claim 2 when executing the computer program.

19. A computer electronic device, comprising a storage and a processor, wherein
the storage is configured to store computer programs;
the processor is configured to implement the heterogeneous three-dimensional observation registration method based on depth phase correlation as described in claim 3 when executing the computer program.

20. A computer electronic device, comprising a storage and a processor, wherein
the storage is configured to store computer programs;
the processor is configured to implement the heterogeneous three-dimensional observation registration method based on depth phase correlation as described in claim 4 when executing the computer program.
